(19) United States
(12) Patent Application Publication
(10) Pub. No.: US 2025/0276203 A1
(43) Pub. Date: Sep. 4, 2025

(54) RACK STORAGE SYSTEM

(71) Applicant: Manfred EBERLE, Illertissen (DE)

(72) Inventor: Manfred EBERLE, Illertissen (DE)

(21) Appl. No.: 19/210,676

(22) Filed: May 16, 2025

Related U.S. Application Data
(63) Continuation of application No. PCT/EP2023/081857, filed on Nov. 15, 2023.

(30) Foreign Application Priority Data
Nov. 17, 2022 (DE) 10 2022 130 509.0

(51) Int. Cl. A62C 3/00; A62C 35/68

(52) U.S. Cl. CPC A62C 3/002; A62C 35/68

(57) ABSTRACT

A rack storage system having at least one compartment support that borders a storage aisle and/or a storage compartment on one side, and having a sprinkler system that includes at least one supply pipe, from which supply pipe a sprinkler pipe having at least one sprinkler head extends into the storage aisle and/or the storage compartment. A deflection element that extends farther toward a floor of the storage aisle than does the sprinkler head is situated on the bottom side of the compartment support.

This nonprovisional application is a continuation of International Application No. PCT/EP2023/081857, which was filed on Nov. 15, 2023, and which claims priority to German Patent Application No. 10 2022 130 509.0, which was filed in Germany on Nov. 17, 2022, and which are both herein incorporated by reference.

### BACKGROUND OF THE INVENTION

### Field of the Invention

The invention relates to a rack storage system having at least one compartment support that borders a storage aisle and/or a storage compartment on one side, and having a sprinkler system that includes at least one supply pipe, from which supply pipe a sprinkler pipe having at least one sprinkler head extends into the storage aisle and/or the storage compartment, wherein a deflection element that extends farther toward a floor of the storage aisle than does the sprinkler head is situated on the bottom side of the compartment support.

### Description of the Background Art

Rack storage systems, in particular in the form of high rack storage systems, are an important element in inventory management and logistics. Such rack storage systems are generally made up of a plurality of compartment supports on which the goods are stored or retrieved; for this purpose, pallets or base plates accommodating the goods may be directly deposited or placed, respectively, on the compartment supports. During both storage and retrieval the goods are guided along the compartment supports, which often reach all the way to the goods in order to make optimal use of the storage capacity. It is noted that multiple storage levels may be situated one above the other to increase the storage capacity.

In such rack storage systems, goods having considerable value are stored which must be protected, in particular against the risk of fire. Therefore, rack storage systems are provided with sprinkler systems via which an extinguishing agent, generally water, that is supplied in a piping system may be distributed by means of sprinklers having a sprinkler head and a baffle plate. These sprinklers are arranged in the storage aisles, and may also be associated with the storage compartments. The sprinkler heads protrude downwardly from the sprinkler tubes of the piping system into free space. These sprinkler heads are thus exposed and at risk of being damaged during the storage and retrieval of the stocked good, for example when the good or a stacker crane moves against them. Even warping of the baffle plate may result in the extinguishing agent no longer being uniformly distributed, and fire or ember pockets not being reached.

To improve this situation, a sprinkler protection system is disclosed in WO 2015/059143 A1, which corresponds to US 2016/0263606, which is incorporated herein by reference, and which is formed from a mounting section, for example pipe clamps, and a protection section that can be fixed to the sprinkler tubes by means of the mounting section. The protection section includes in particular guard brackets, enclosing the sprinkler head, which prevent direct contact with the sprinkler upon a given application of force.

However, it is important to note that in the conventional art, a protection section should interfere as little as possible with a distribution of an extinguishing agent, and an extension and dimensions are therefore also limited with regard to the material thickness.

### SUMMARY OF THE INVENTION

It is therefore an object of the present invention to provide a rack storage system that improves the protection of the sprinkler head from damage.

The rack storage system according to an example of the invention is characterized in that protection of the sprinkler head may also be improved by limiting the height of the upper edge of the goods when the goods are being maneuvered during storage or retrieval, and when the allowable height is exceeded, for example due to excessively high storage of the goods on a pallet, contact is prevented by deflection of the contact partner by the deflection element, which deflects the contact partner downwardly toward the floor in a form-fit manner. It is pointed out that a great material thickness is quite possible for the deflection element, since its association with the compartment support avoids space limitations, and diversion of the acting force is ensured. In addition, shielding of the extinguishing agent is largely avoided, since the distance from the sprinkler head is great, and only a small solid angle adjoining the compartment support is affected.

It is particularly advantageous that the protective effect additionally occurs, and that it is also possible for a protective device to be associated with the sprinkler head, the protective device having at least one guard bracket that encloses the sprinkler head and is fastened to the sprinkler pipe, and for the deflection element to extend farther toward the floor of the storage aisle than does the guard bracket. It has proven suitable for the protective device to have two guard brackets, one situated on each side of the sprinkler head, which at their free ends each have a thread via which the guard brackets are fastened to the sprinkler pipe by means of pipe clamps.

The protective effect is particularly great when the deflection element is situated at the compartment support at the side of the sprinkler head, so that the projection of the sprinkler head or of the protective device coincides with that of the deflection element. It is also conceivable to position the deflection element in front of the sprinkler head in the direction of movement of the contact partner and to force a deflection early; however, a subsequent height adjustment is then quite possible, or a large extension is necessary.

The deflection element can be formed as a wedge that becomes thicker, from the entry to the storage aisle and/or the storage compartment, in the direction of the sprinkler head until the wedge protrudes beyond the sprinkler head or the protective device toward the floor. The wedge offers the advantage, over a mere stop, that no abrupt stopping occurs with a great action of force on the goods and/or the stacker crane, and instead, an increased resistance for the operator gradually builds up, which may also trigger a response by the operator to make a height correction.

In practice, it is suitable for the compartment support to be formed as a T-beam, with a crossbar that points toward the floor, with the wedge fastened to its free ends. The T-beam may in particular be formed as a double T-beam in the sense of optimized load-bearing capacity regarding the goods deposited on top; however, using the crossbar positioned at the bottom, which provides free areas at which the fastening can take place, is sufficient, in particular when the wedge is formed by two wedge brackets that are fastened to the edge of the compartment support.

There is also the option to provide two bracket plates with passages for fastening the wedge brackets to the compartment support, and with passages for the wedge brackets.

Alternatively, the wedge may be formed as a plate, with a bar that determines the thickness of the wedge protruding at the end of the plate associated with the sprinkler head.

The width of the plate may exceed the width of the compartment support, it also being possible for cross braces, whose width exceeds the width of the compartment support, to be situated at the free ends of the plate. Free areas at which a fastener may be situated are thus available at the plate or at the cross braces.

The wedge can be formed from two wedge halves having a groove, on their mutually facing sides, for fastening to the crossbar. This example utilizes the design of the T-beam for simple fastening and provision of a maximized material thickness.

The wedge can have a flat area in the region of the sprinkler head or the protective device; i.e., no further rise of the wedge has to take place over the extension of the sprinkler head.

The compartment support storage compartments can be provided multiple times to form a plurality of storage aisles and/or storage compartments, into each of which a supply pipe together with the at least one sprinkler head protrudes, so that the capacity of the rack storage system may be adjusted as needed.

When the wedge is formed as a double wedge in the direction of extension of the storage aisle, protection is provided not just in one direction of movement of the good.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective schematic illustration of a rack storage system having two storage compartments, with supply pipes, pointing into the storage compartments, for one sprinkler head each,

FIG. 2 shows a view from the direction of the arrow II from FIG. 1, illustrating the overlap of a deflection element and the sprinkler,

FIG. 3 shows a schematic illustration of the deflection element, formed as a wedge designed as a plate, mounted on the bottom side of the compartment support formed as a double T-beam,

FIG. 4 shows a perspective isolated illustration of the plate from FIG. 3,

FIG. 5 shows a perspective illustration of the subject matter from FIG. 3,

FIG. 6 shows an illustration, corresponding to FIG. 3, with a wedge that is formed from two wedge halves that are fastened to the T-beam via a groove,

FIG. 7 shows a perspective illustration of a wedge half,

FIG. 8 shows a perspective illustration of the two wedge halves at the crossbar of the T-beam,

FIG. 9 shows an illustration, corresponding to FIG. 3, with a wedge that is formed from two wedge brackets,

FIG. 10 shows a perspective illustration of the two wedge brackets at the crossbar of the T-beam,

FIG. 11 shows a top view of a bracket plate for fastening one end of the wedge brackets, and

FIG. 12 shows a top view of a further bracket plate for fastening the other end of the wedge brackets.

### DETAILED DESCRIPTION

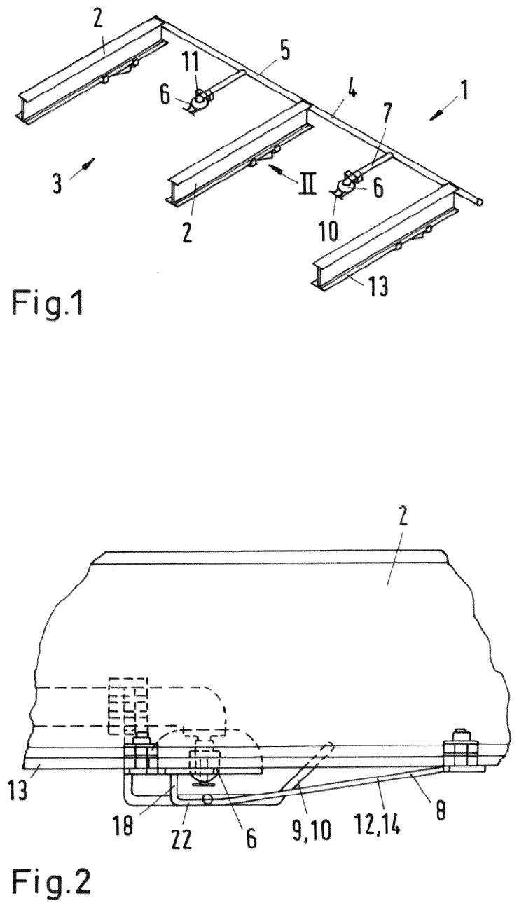

FIG. 1 shows the parts of a rack storage system 1 necessary for explaining the invention. A rack storage system 1 is shown that has at least one compartment support 2, which in particular may be present with a design as a cantilever arm; three compartment supports 2 are present in the example shown. To increase the storage capacity, the number of compartment supports 2 may be increased, in particular in the storage level shown as well as in further storage levels at other heights. The compartment supports 2 may also border a storage aisle at the edge of the rack storage system, via which goods for storage and retrieval are transported. According to the example shown, the compartment supports 2 border a storage compartment 3 in which the goods may be stored, in particular on pallets.

The rack storage system 1 has a sprinkler system 4 with a supply pipe 5, from which a sprinkler pipe 7 that has at least one sprinkler head 6 extends into the storage aisle and/or the storage compartment 3.

Situated on the bottom side of the compartment support 2 is a deflection element 8 which extends farther toward a floor of the storage compartment 3 than does the sprinkler head 6 (FIG. 2) or a protective device 9 that is associated with the sprinkler 6. In the example shown, this protective device 9 includes two guard brackets 10 which enclose the sprinkler head 6, and which are fastened to the sprinkler pipe 7 in that a thread is provided at their free ends in each case, via which the guard brackets 10 may be fastened to the sprinkler pipe 7 by means of pipe clamps 11.

It is apparent from FIG. 1 that the deflection element 8 is situated at the compartment support 2 at the side of the sprinkler head 6, in particular in such a way that the linear projection of the sprinkler head 6 or of the protective device 9 coincides with that of the deflection element 8; this situation is also apparent from FIG. 2.

In the exemplary example shown, the deflection element 8 is formed as a wedge 12 that becomes thicker, from the entry to the storage aisle and/or the storage compartment 3, in the direction of the sprinkler head 6 until the wedge 12 protrudes beyond the sprinkler head 6 or the protective device 9 toward the floor. The compartment support is formed as a T-beam, with a crossbar 13 that points toward the floor, with the wedge 12 fastened to its free ends.

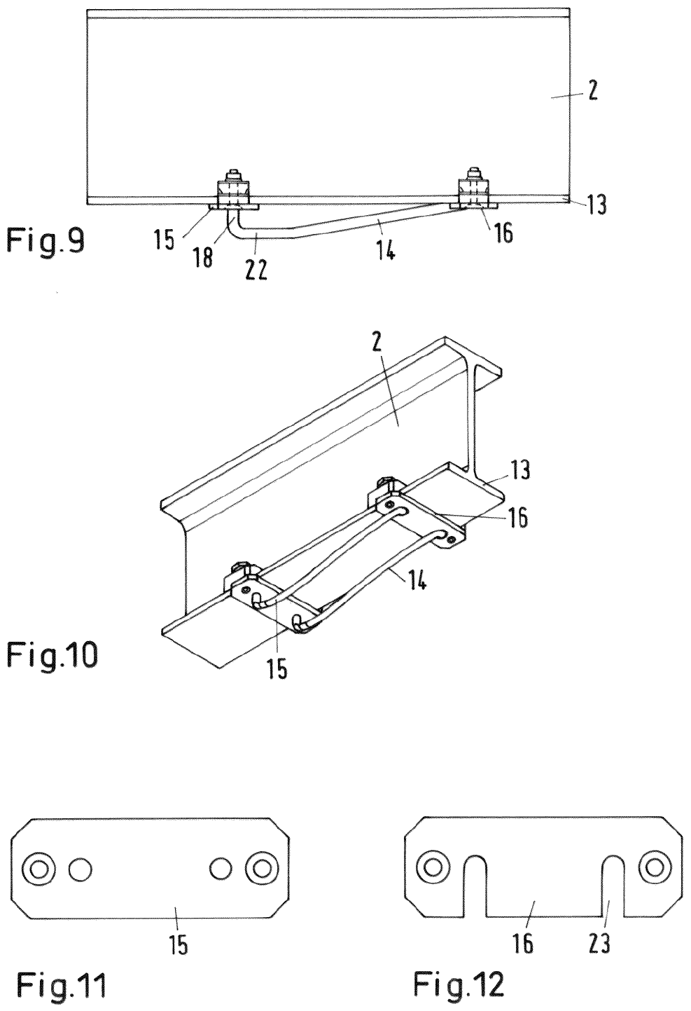

FIGS. 1, 2, 9, and 10 show that the wedge 12 is formed by two wedge brackets 14 that are fastened to the edge of the compartment support 2, for which purpose two bracket plates 15, 16 are provided with passages for fastening the wedge brackets 14 to the compartment support 2, and with passages for the wedge brackets 14, which are shown in isolated form in FIGS. 11 and 12. The first bracket plate 15 has two holes for fastening screws as well as two holes for the wedge brackets 14 as passages, while for the second bracket plates 16, the holes for the wedge brackets 14 are expanded to form elongated holes 23 that reach to the edge, so that the ends of the wedge brackets 14 may be accommodated therein, even when the wedge 12 travels close to the compartment support 2.

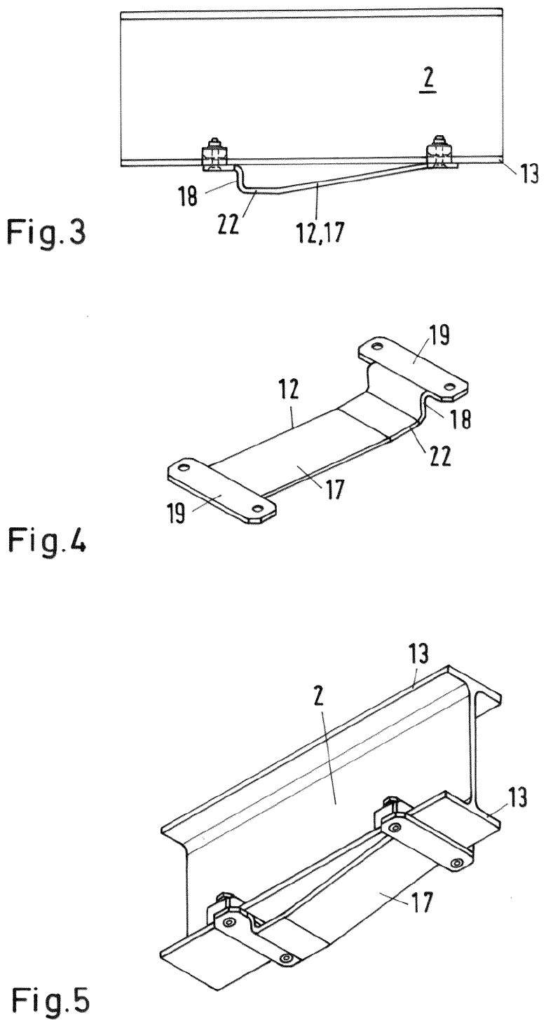

FIGS. 3 through 5 show that the wedge 12 is formed as a plate 17, at whose end associated with the sprinkler head 6 a bar 18 that determines the thickness of the wedge 12 protrudes (FIG. 3), while the width of the plate 17 exceeds the width of the compartment support 2, or cross braces 19 whose width exceeds the width of the compartment support 2 are situated at the free ends of the plate (FIG. 4). This overhang may be used for the fastening in order to guide the fastening screws laterally past the compartment support 2.

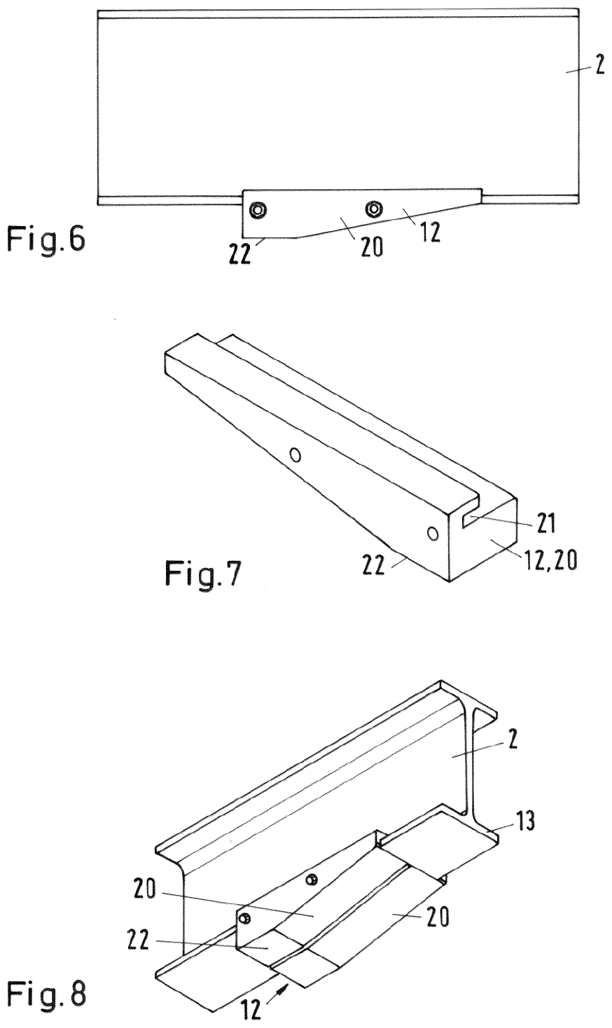

A further example is shown in FIGS. 6 through 8, in which the wedge 12 is formed from two wedge halves 20 having a groove 21, on their mutually facing sides, for fastening to the crossbar 13.

All of the shown examples share the feature that the wedge 12 has a flat area 22 in the region of the sprinkler head 6 or of the protective device 9; i.e., a further increase in the wedge height is not necessary when the required height in the region of the sprinkler head 6 is reached.

According to an example, the wedge 12 may be formed as a double wedge in the direction of extension of the storage aisle and/or of the storage compartment 3, this example being particularly suitable for use in a storage aisle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A rack storage system comprising:
at least one compartment support that borders a storage aisle and/or a storage compartment on a side;
a sprinkler system that includes at least one supply pipe from which a sprinkler pipe having at least one sprinkler head extends into the storage aisle and/or the storage compartment; and
a deflection element that extends farther toward a floor of the storage aisle than the sprinkler head, the deflection element being arranged a bottom side of the compartment support.

2. The rack storage system according to claim 1, wherein a protective device is associated with the sprinkler head, wherein the protective device has at least one guard bracket that encloses the sprinkler head and that is fastened to the sprinkler pipe, and wherein the deflection element extends farther toward the floor of the storage aisle than the guard bracket.

3. The rack storage system according to claim 1, wherein the protective device has two guard brackets, one situated on each side of the sprinkler head, which at their free ends each have a thread via which the guard brackets are fastened to the sprinkler pipe via pipe clamps.

4. The rack storage system according to claim 2, wherein the deflection element is situated at the compartment support at the side of the sprinkler head so that the projection of the sprinkler head or of the protective device coincides with that of the deflection element.

5. The rack storage system according to claim 2, wherein the deflection element is formed as a wedge that becomes thicker, from the entry to the storage aisle and/or the storage compartment, in a direction of the sprinkler head until the wedge protrudes beyond the sprinkler head or the protective device toward the floor.

6. The rack storage system according to claim 5, wherein the compartment support is formed as a T-beam, with a crossbar that points toward the floor, with the wedge fastened to its free ends.

7. The rack storage system according to claim 5, wherein the wedge is formed by two wedge brackets that are fastened to the edge of the compartment support.

8. The rack storage system according to claim 7, wherein two bracket plates are provided with passages for fastening the wedge brackets to the compartment support, and with passages for the wedge brackets.

9. The rack storage system according to claim 5, wherein the wedge is formed as a plate, with a bar that determines the thickness of the wedge protruding at the end of the plate associated with the sprinkler head.

10. The rack storage system according to claim 9, wherein the width of the plate exceeds the width of the compartment support, or cross braces whose width exceeds the width of the compartment support are situated at the free ends of the plate.

11. The rack storage system according to claim 6, wherein the wedge is formed from two wedge halves having a groove on their mutually facing sides for fastening to the crossbar.

12. The rack storage system according to claim 5, wherein the wedge has a flat area in a region of the sprinkler head or the protective device.

13. The rack storage system according to claim 1, wherein the compartment support is provided multiple times to form a plurality of storage aisles and/or storage compartments, into each of which a supply pipe together with the at least one sprinkler head protrudes.

14. The rack storage system according to claim 5, wherein the wedge is formed as a double wedge in a direction of extension of the storage compartment.
